(19) United States
(12) Patent Application Publication
(10) Pub. No.: US 2024/0254325 A1
(43) Pub. Date: Aug. 1, 2024

(54) THERMOSETTING CASTING COMPOSITION, MOLDED ARTICLE MADE THEREFROM AND PROCESS FOR PRODUCING SUCH A MOLDED ARTICLE

(71) Applicant: Schock GmbH, Regen (DE)

(72) Inventors: Vitaliy DATSYUK, Zwiesel (DE); Adam ORENDORZ, Zwiesel (DE)

(21) Appl. No.: 18/426,767

(22) Filed: Jan. 30, 2024

(30) Foreign Application Priority Data
Jan. 30, 2023 (DE) 10 2023 102 130.3

(51) Int. Cl. C08L 33/06; B29C 39/00; B29C 39/02; B29C 39/38; B29K 1/00; B29K 21/00; B29K 33/04; B29K 105/00; B29K 105/16; B29K 105/26; B29L 31/00; C08K 3/26; C08K 3/36; C08K 11/00

(52) U.S. Cl. CPC C08L 33/062; B29C 39/006; B29C 39/38; C08K 3/26; C08K 3/36; C08K 11/00; B29C 39/026; B29K 2001/00; B29K 2021/006; B29K 2033/04; B29K 2105/0002; B29K 2105/0085; B29K 2105/16; B29K 2105/26; B29L 2031/7692; B29L 2031/7698; C08K 2003/265; C08K 2003/267; C08K 2201/005; C08L 2203/30; C08L 2205/025; C08L 2205/03; C08L 2207/20

(57) ABSTRACT

A thermoset polymerizable casting compound, formulated for production of kitchen sinks and sanitary ware, including: (a) at least one monofunctional acrylic and/or methacrylic monomer from recycled material and/or of plant or animal origin, (b) at least one polyfunctional acrylic and/or methacrylic biomonomer of plant or animal origin, (c) at least one polymer or copolymer selected from (co)polyacrylates, (co)polymethacrylates, polyols, polyesters, rosins, polyterpene resins, each from recycled material or of plant or animal origin, where the substances according to (a)-(c) form a polymer binder, and (d) inorganic and/or organic filler particles of natural origin or from recycled material. The proportion of the monofunctional acrylic and/or methacrylic monomer(s) and of the polyfunctional acrylic and methacrylic biomonomer(s) is 10-40% by weight, the proportion of the polymer(s) or copolymer(s) is 1-16% by weight, the proportion of the inorganic and/or organic filler particles is 44-89% by weight, and the polymer binder further includes at least one polymerizable terpene or derivatives thereof.

### CROSS-REFERENCE TO RELATED APPLICATIONS

The present application claims priority of DE 10 2023 102 130.3, filed Jan. 30, 2023, the priority of this application is hereby claimed, and this application is incorporated herein by reference.

### BACKGROUND OF THE INVENTION

The present invention relates to a thermoset casting compound suitable for forming at low temperature (redox-induced cold curing) and at high temperature (heat-induced high-temperature curing), and having excellent molding processability. The invention further relates to a shaped body produced therefrom in the form of a kitchen sink, a shower tray, a wash basin or a bathtub that has a good appearance, high impact resistance and good thermal stability and thermal cycling stability. Finally, the invention relates to a method of producing shaped articles, for example kitchen sinks, shower trays, wash basins, bathtubs.

Shaped bodies in the form of kitchen sinks, shower trays, wash basins or bathtubs that are produced by compounding of inorganic fillers such as quartz sand and organic fillers such as olive kernels in a petrochemical or biobased acrylic resin have various excellent functions and properties, for example variety of color, smooth surfaces of good cleanability, weathering resistance and mechanical and thermal properties. The shaped articles are typically produced by a casting method in which a casting compound is first produced by dispersing inorganic and organic fillers in an acrylic syrup composed of methyl methacrylate or a mixture of biobased and/or recycled acrylic monomers and polymethylmethacrylate or a mixture of acrylates, polyesters, polyols and copolymers thereof. Subsequently, this casting compound is introduced into a mold, and cured and polymerized at high temperature. The most important properties of such shaped articles in the kitchen or in the sanitary sector are their impact resistance (break resistance on transport or on assembly) and cleanability (kitchens and sanitary ware must be able to be kept clean for healthy living). Typical values for impact resistance (measured to ISO 179) are in the range of 1.8-2.5 mJ/mm2 and for color change (DE) after performance of the cleaning test (to EN 14688) in the range of 4.5-9.5.

For example, U.S. Pat. No. 6,841,253 discloses shaped plastic articles in the form of kitchen sinks, wash basins, bathtubs, shower trays, having excellent cleanability and abrasion resistance, which are produced by a casting method, wherein the casting compound composition comprises quartz filler and polymer binder components composed of a methacrylate, crosslinking agents and fluoropolymer particles, and which is cured in a mold at 100° C. and for 30 minutes. It is known that fluoropolymers are superhydrophobic [Y. Huang et al., Materials and Design, 162 (2019) 285] and the use of fluoropolymers increases the hydrophobicity of the polymer surface. A higher hydrophobicity of the surface increases the cleaning barrier in the product.

But since this casting compound contains fluoropolymer particles, the use of such shaped bodies in the kitchen or in sanitary spaces can cause fluoropolymer-associated respiratory disorders. The outcomes are predominantly acute respiratory disorders that are accompanied by flu-like symptoms (Hays & Spiller, Clinical Toxicology (2014), 52, 848-855).

In order to avoid the use of hazardous fluoropolymer compounds, shaped articles such as kitchen sinks and other sanitary ware, for example, that have an elevated concentration of the crosslinking agent have been developed. For example, patent DE10 2004 055 365A1 discloses a shaped plastic body having an elevated amount of the crosslinking agent which has higher reactivity than methyl (meth)acrylate (MMA) and produces the thin film on the top face of the plastic body, which provides improved cleanability. But since the casting compound composition includes an extremely high number of crosslinking agents, the shaped article has a very high degree of crosslinking, which can lead to creation of internal microstresses in the shaped plastic body and hence to a reduction in impact resistance of the body.

In order to prevent the production of shaped articles with reduced mechanical performance, it is possible to use cyclic derivatives of methacrylate monomers, for example isobornyl methacrylate (IBOMA) and cyclohexyl methacrylate (CHMA), in the casting compound. For example, patent application IT 2016 00108376 A1 discloses a casting composition having a high proportion of IBOMA and CHMA and a shaped article for kitchen and/or bathroom sinks having improved cleanability. Similarly to fluoropolymers, polyIBOMA and polyCHMA have a higher hydrophobicity compared to pure polymethylmethacrylate-based acrylic resin, which leads to improved cleanability. However, the introduction of a large amount of IBOMA and CHMA into the structure of the shaped plastic article leads to a reduction in thermal cycling stability, which is a crucial property for kitchen sinks in particular, where it is expected that there will be regular contact of the sink with hot or boiling water, for example as a result of the pouring-out of water in which pasta has been boiled.

### SUMMARY AND DESCRIPTION OF THE INVENTION

It is an object of the invention to specify an improved casting compound that permits the production of shaped articles, especially having an aesthetic appearance, good mechanical and thermal properties, and good cleanability.

The problem is solved by providing a thermoset polymerizable casting compound formulated for production of kitchen sinks and sanitary ware, comprising:
(a) one or more monofunctional acrylic and/or methacrylic monomers, where one or more monomers come from recycled material and one or more monomers are of plant or animal origin,
(b) one or more polyfunctional acrylic and/or methacrylic biomonomers of plant or animal origin,
(c) one or more polymers or copolymers selected from (co)polyacrylates, (co)polymethacrylates, polyols, polyesters, rosins, polyterpene resins, each from recycled material or of plant or animal origin,
where the substances according to (a)-(c) form a polymer binder,
(d) inorganic and/or organic filler particles of natural origin or from ground recyclate, wherein the proportion of the monofunctional acrylic and/or methacrylic monomer(s) and of the polyfunctional acrylic and methacrylic biomonomer(s) is 10-40% by weight, the proportion of the polymer(s) or copolymer(s) is 1-16% by weight and the proportion of the inorganic and/or organic filler particles is 44-89% by weight, and the polymer binder further comprises at least one polymerizable terpene or derivatives thereof.

The thermoset casting compound of the invention has the feature that it comprises, in the polymer binder, in addition to the mono- and polyfunctional acrylic/methacrylic monomers with dissolved polymers or copolymers and filler particles incorporated into the casting compound, at least one polymerizable terpene, or contains a derivative.

Polymerizable terpenes and derivatives thereof can copolymerize with (meth)acrylic monomers, which increases the hydrophobicity of the surface, improves cleanability (similarly to the case of fluoropolymers or incorporated cyclic methacrylic monomers), but at the same time increases the flexibility of the hard and brittle acrylic resin.

It is surprising that the addition of terpineol in the casting compound especially improves the process of demolding the shaped articles after polymerization, especially from molds made of glass fiber composite materials (GFRP molds). The addition of the terpenes prevents the destruction of the separating agent layers and of the gelcoat that are present on the top face of the GFRP mold. During the polymerization, these are attacked by the evolution of high temperature and the acrylates used when the Trommsdorff effect occurs during the polymerization of methacrylate-based monomers. Further addition of polymerizable terpenes has the effect that the shaped article, because of the plastifying effect in the copolymerization of the methacrylate-based monomers with terpineol, gains improved impact resistance.

As well as the possibility that the casting compound contains just one polymerizable terpene, it may also contain a mixture of two or more polymerizable terpenes and derivatives thereof. It is thus possible to combine different properties of different terpenes by means of such a mixture and to impart a broad spectrum of properties required for the shaped article to the casting compound and ultimately to the cast shaped article.

A multitude of terpenes and derivatives thereof may be used. The terpenes or the two or more terpenes and derivatives thereof that form the mixture are preferably selected from, but are not limited to, α-terpineol, β-terpineol, γ-terpineol, terpinen-4-ol and mixtures thereof, terpinolene as a menthadiene, (Z)-2,6-dimethyl-2,6-octadien-8-ol as an acyclic monoterpene alcohol, myrcene as a monoterpene. All these polymerizable terpenes and derivatives thereof copolymerize with (meth)acrylic monomers, introducing the hydrophobic segments into the resin structure to improve cleanability and for plastifying action, as a result of which the resin becomes more stable against mechanical and thermal shock.

The amount of the proportion of the polymerizable terpene and derivatives thereof or of the terpene mixture should be in the range of 0.1-20% by weight based on the casting compound. This means that even a very small proportion of oil is sufficient to bring about a distinct improvement in the properties of the shaped body. The terpene content, or the proportion of the terpene mixture, should preferably be 0.8-15% by weight; the proportion should preferably be between 1-10% by weight.

Kitchen sinks and sanitary ware can be produced in different ways and using different casting compound compositions. The variety of options is described, for example, in DE 38 32 351 A1, DE 10 2004 055 365 A1 or DE 10 2019 125 777 A1. In the case of exchange of the initiator system of heat-activated peroxides (di-(4-tert-butylcyclohexyl) peroxydicarbonate and lauryl peroxide mixture) for a redox-activated initiator system (benzoyl peroxide-ethoxylated p-toluidine), the casting compounds of DE 38 32 351 A1, DE 10 2004 055 365 A1 or DE 10 2019 125 777 A1 can be cured at room temperature.

In principle, it is then possible to use different casting compounds for production of the shaped articles. It has been found that they can constitute a basis for the casting compound of the invention.

In a typical formulation, the casting compound of the invention should then, for example, as well as polymerizable terpenes and derivatives thereof, contain a proportion of polyfunctional (meth)acrylic monomers of petrochemical origin which has been freshly synthesized, i.e. is non-recycled, or of biobased origin, which has been recycled, where the proportion is in the range of 0.5-20% by weight, preferably 0.8-15% by weight, preferably 1-10% by weight.

Variation in the amount of polyfunctional monomers that for production of shaped articles having a different degree of crosslinking is permissible as a reaction to the specific demands of different applications. For example, kitchen sinks need a harder surface compared to shower trays, which can be achieved by a higher degree of crosslinking. By contrast, the shower tray must be more flexible in order to react to the stresses that are exerted by the human body when stepping on the tray.

The dominant component of the thermoset casting compound of the invention based on the proportion by weight thereof is filler particles. The filler particles of the invention may be inorganic filler particles that impart hardness to the materials, organic filler particles that make the material lighter, and recyclates that make it possible to reuse production rejects and kitchen sinks and other shaped articles at the end of their lifetime, and to reduce the proportion of nonbiodegradable plastic waste. The fillers may also take the form of a mixture of two or more or all of the aforementioned types of particle.

The inorganic filler particles in the casting compound of the invention are preferably selected from SiO₂, Al₂O₃, TiO₂, ZrO₂, Fe₂O₃, ZnO, Cr₂O₅, SiC, CaCO₃, BaSO₄, carbon, metals or metal alloys, although it is also possible to use mixtures of two or more different types of filler particles. The mixing ratio may be any desired ratio.

The organic filler particles in the casting compound of the invention are preferably selected from ground olive kernels, almond kernels, peach kernels, cherry kernels, apricot kernels, avocado peel, argan shells, cocoa shells. The lightweight character of the shaped article cured from the thermoset casting compound of the invention is a very important feature for kitchen sinks, wash basins and in particular bathtubs, which can weigh hundreds of kilograms. Furthermore, organic filler particles such as fruit kernels play an important role in the attainment of high mechanical and thermal performance. Lignin and hardwood cellulose are the basis of olive kernels. Shear forces in the mixing of the casting compound open up the fibrous structure composed of lignin and cellulose, which gives rise to particles of the core-hair type that improve the filler-matrix interface. The ends of lignin and cellulose fibers penetrate into the polymer matrix and increase impact resistance and thermal cycling stability.

Recyclates in the casting compound of the invention are selected in the form of ground particles of shaped articles made from a thermoset casting compound, for example kitchen sink and sanitary wastes according to DE 10 2021 127 484.2 or, for example, recycled wind turbine blades according to U.S. Pat. No. 10,953,407 B2. Depending on the starting material, the recyclates are quartz composites, engineered stone composites, mineral material composites or glass fiber composite materials.

The inorganic, organic and recycled filler particles in the casting compound of the invention preferably have a particle size of 1 to 1200 μm, more preferably 25 to 1000 μm and especially 50 to 800 μm.

As well as the casting compound of the invention, the invention further relates to a shaped body produced using a casting compound of the invention as described above. Depending on the casting compound used, in relation to the constituents of the compound other than the terpene and derivatives thereof, the shaped body produced may be partly or fully biobased. In any case, the terpenes and derivatives thereof are supplied from biological sources, and hence the shaped body produced in accordance with the invention is a biocomposite-based shaped article.

The thermoset casting compound of the invention can be used to produce various types of shaped bodies. The shaped article may, for example, be a kitchen sink, a shower tray, a wash basin or a bathtub.

The invention further relates to a method of producing a shaped body of the type described above, in which a casting compound of the type described above is introduced into an empty mold, where it is polymerized under cold-curing conditions using a redox-induced curing system.

The casting composition is polymerized in the mold in the redox-induced cold-curing operation at a temperature of 10 to 70° C., preferably of 12 to 50° C., more preferably of 15 to 30° C.

The invention further relates to the shaped article of the type described above, in which a casting compound of the type described above is introduced into an empty mold, where, as an alternative to cold curing, it is also polymerized using a heat-induced curing system.

The casting compound is polymerized in the mold for the heat-induced curing method at a temperature of 70 to 120° C., preferably of 80 to 110° C., more preferably of 90 to 100° C.

In the present invention, the kitchen sink article or sanitary ware item has a content of terpenes and derivatives thereof in a concentration of 0.1% by weight or more, up to a maximum of 20% by weight. Terpenes and derivatives thereof are a large group of volatile unsaturated hydrocarbon derivatives that are extracted from the essential oils of plants, especially conifers and citrus trees. Terpenes form a large but also heterogeneous class of chemical compounds that are based structurally on isoprene units (C₃H₈)ₙ and have alcohols as their most common derivatives. These substances can enter into a strong chemical or physical bond with the filler particles (quartz sand or fruit kernels, which have numerous hydroxyl groups on their surface). On the other hand, the presence of double bonds in the molecular structure makes it possible for terpineols to copolymerize with (meth)acrylic monomers of the binder, which improves the corresponding properties of the shaped bodies produced from the casting compound of the invention even at low concentrations.

We give some examples hereinafter of the efficient use of the casting compound of the invention and hence of the shaped body of the invention.

### Example 1

### Components Used:

### Monofunctional Monomers:

Monofunctional biobased monomers: isobornyl methacrylate (IBOMA, Evonik Performance Materials GmbH), lauryl methacrylate, ethyl methacrylate (BCH Brühl Chemikalien Handel GmbH). These components are all of plant or animal origin; for example, VISIOMER® Terra IBOMA is produced from pinewood resin.
Monofunctional recycled monomer: monofunctional recycled monomer methacrylate (rec.-MMA, Monómeros del Vallés, S.L.).

### Terpenes and Derivatives Thereof:

Terpineol (International Flavors and Fragrances).

### Polyfunctional Monomers:

Polyethylene glycol 200 dimethacrylate (PEG200DMA) (Arkema France).

### Polymers:

Finely ground XP 95 acrylic glass (recycled PMMA, Kunststoff-und Farben-GmbH).

### Filler:

SiO₂, quartz sand (Dorfner GmbH); ground quartz of grain size 0.1-0.70 μm (Quarzwerke GmbH), ground olive kernels (Bio Powder), natural dyes (Kreidezeit).

### Additives:

Biobased dispersing additives (0.1%) (BYK-Chemie GmbH) and thixotropic additives (0.1%) (BYK-Chemie GmbH), internal separating agent (Münzing).

The compositions for production of polymer matrices are produced by dissolving finely ground XP 95 acrylic glass (recycled PMMA, Kunststoff-und Farben-GmbH) in a mixture of monofunctional monomers from table 1: methyl methacrylate (Monómeros del Vallés), isobornyl methacrylate (Evonik Performance Materials GmbH), ethyl methacrylate (BCH Brühl Chemikalien Handel GmbH). The reaction mixture was heated to 40° C. in order to accelerate solubility to 100 min and finally to obtain a clear solution. After the clear solution of PMMA in the mixture of monofunctional monomers has been obtained, the viscosity of the composition obtained is measured at 120 to 155 cPs (Brookfield Viscometer DVI Prime). Subsequently, bio(decane-1,10-diol dimethacrylate) (Arkema) is added.

The clear solution of finely ground XP 95 acrylic glass in experiments 1-3 with addition of bio-PEG200DMA and terpineol was used to disperse a mixture of inorganic and organic fillers (quartz sand (Dorfner GmbH), ground quartz (Quarzwerke GmbH), ground olive kernels (Bio Powder) and natural pigment particles (Kreidezeit)). Also added were biobased dispersing additives (0.1%) (BYK-Chemie) and thixotropic additives (0.1%) (BYK-Chemie) and an internal separating agent (Münzing).

The quantitative composition of the casting compounds is summarized in Table 1.

TABLE 1
Formulations of the casting compound for heat-induced
polymerization of shaped articles (figures in % by weight)

| | | | Shaped body for |
|---|---|---|---|
| Constituents | | | comparison |
| (with specification of | Shaped body | of the invention | Comparative |
| manufacturer) | Specimen 1 | Specimen 2 | specimen 1 |
| Methyl methacrylate, | 19.4 | 19.4 | 19.4 |
| Monómeros del Vallés | | | |
| Polymethylmethacrylate, | 5.7 | 5.7 | 5.7 |
| KF GmbH | | | |
| Terpineol, International | 0.6 | 0.2 | 0 |
| Flavors and Fragrances | | | |
| Isobornyl methacrylate, | 0.7 | 0.7 | 0.7 |
| Evonik | | | |
| Ethyl methacrylate, BCH | 2.3 | 2.3 | 2.3 |
| Brühl Chemikalien | | | |
| Handel | | | |
| PEG(200)DMA, Arkema | 1.5 | 1.5 | 1.5 |
| Peroxides, Pergan | 0.6 | 0.6 | 0.6 |
| Dispersing additive, | 0.2 | 0.2 | 0.2 |
| BYK-Chemie | | | |
| Thixotropic additive, | 0.1 | 0.1 | 0.1 |
| BYK-Chemie | | | |
| Quartz sand, Dorfner | 53.0 | 53.0 | 53.0 |
| Ground quartz, | 6.7 | 6.7 | 6.7 |
| Quarzwerke | | | |
| Organic filler, Bio | 6.0 | 6.0 | 6.0 |
| Powder | | | |
| Pigment, Kreidezeit | 3.1 | 3.1 | 3.1 |
| Internal separating agent, | 0.1 | 0.1 | 0.1 |
| Münzing | | | |

The casting compound thus produced was stirred for 20 minutes (Dispermat AE-3M, VMA-Getzmann GmbH). The casting compound was used to produce a shaped body in each case in the form of a kitchen sink by pouring the respective casting compound into a mold and polymerizing at 110° C. for 35 minutes.

TABLE 2
Properties of the kitchen sinks from table 1

| | Specimen | Specimen | Comparative |
|---|---|---|---|
| Properties | 1 | 2 | specimen 1 |
| Impact resistance, mJ/mm² | 3.3 | 3.2 | 3.0 |
| Taber abrasion, μg | 16.2 | 19.6 | 21.2 |
| Steam test, DE: color change | 0.46 | 0.74 | 1.03 |
| Soiling test, DE: color change | 0.98 | 1.23 | 3.39 |

For impact resistance measurements, 12 samples of dimensions 80×6 mm were cut out of the sink. The measurements were conducted using a ZwickRoell HIT P pendulum impact tester instrument. For the Taber abrasion test, a sample (100×100 mm) is cut and the abrasion test is conducted on an Elcometer 1720 instrument.

Stability against steam is carried out by the following method: a flat sample (100×100 mm) was cut out of the kitchen sink produced and the color thereof was measured by spectrophotometry with a Datacolor colorimetry system. The sample was introduced into the wide-neck Erlenmeyer flask filled with 270 ml of boiled distilled water, which remains on the slightly heating hot plate. The load weight (1 kg) was placed onto the sample, which prevents the sample from vibrating. After 60 min, the sample is removed from the wide-neck flask with crucible tongs, dried (at RT) for 24 hours and then measured. After 24 hours, the color measurement is repeated, and the difference (DE) after and before the steam treatment characterizes the steam stability of the sample.

For the soiling test (EN 14688), the sample (100×150 mm) was cut out of the sink and the color thereof was measured by spectroscopy using a Datacolor colorimetry system. After the measurement, the 5 drops of test soiling solution (IPP 2, WFK Testgewebe GmbH) are mixed in a beaker with the moistened brush. This brush is used to make 5 horizontal lines having a length of about 8 cm alongside one another on the test specimen. 5 vertical lines are likewise applied alongside one another on the horizontal line. After a drying time of 1 h at room temperature, the sample is subjected to preliminary cleaning with hot water (˜60° C.) and an attenuated waterjet at an angle of ˜80°. Subsequently, about 5 g of cleaning suspension (Viss Cremereiniger Original) is applied to the test soiling site, the cleaning body that has been provided with a new sponge is inserted into the stirrer system, and with a weight of 4 kg the lab racks are lifted up to the test soiling site by turning. The stirrer system (Buddeberg GmbH) begins to rotate the ball valve lever on the compressed air supply of the stirrer system. After 25 rotations, which can be read off on the mechanical counter, the sample is rinsed under flowing cold water and then dried. After drying overnight, the color measured at the stress site and the result thereof is recorded together with the initial color measurement. Difference in color value characterizes the soiling test (cleanability) of the samples.

The DE value reported in Table 2 describes the overall color change:

$$DE = \sqrt{{DL}^{2} + {Da}^{2} + {Db}^{2}}$$

where:
DL: color variance in brightness
Da: color variance on the red/green axis
Db: color variance on the yellow/blue axis

Table 2 shows that the kitchen sinks of the present invention show a slight or up to 10% increase in impact resistance compared to the terpene-free comparative specimen. Addition of 0.6% by weight of the terpineol to the formulation leads to a 25% improvement in abrasion resistance. An increase in steam stability was also found in the kitchen sinks as a result of the addition of terpineol. Even at the low concentration (0.2% by weight), a distinct increase in soiling resistance was found.

### Example 2

The increasing number of important properties for kitchen sinks and sanitary ware was also found during the performance of the redox curing (cold curing without heating) of the casting composition of the present invention.

The raw materials used are the same as described for Example 1, with the exception of the additional initiation system, in which a redox accelerator was added in addition to the peroxide. Typical reducing agents for redox-curing acrylic systems are amine-based. The test series presented in Example 2 involves ethoxylated p-toluidine (Pergan GmbH). All other components are from the same manufacturers/suppliers as described in Example 1, except for the pigment. In the case of redox-cured casting compositions, titanium dioxide (Crystal International) was used as white pigment. In addition, in Example 2, various terpenes and derivatives thereof were used: β-myrcene (Thermo Fisher Scientific), Nerol 900 (International Flavors and Fragrances), terpinolene (ARAE), geraniol (International Flavors and Fragrances).

The compositions for production of polymer matrices were produced by dissolving finely ground XP 95 acrylic glass (recycled PMMA, Kunststoff-und Farben-GmbH) in the mixture of methyl methacrylate (Monómeros del Vallés) and polyethylene glycol (PEG)200 dimethacrylate (PEG200DMA). The reaction mixture was heated to 40° ° C. in order to accelerate solubility to 100 min, in order to obtain a clear solution.

The clear solution of finely ground XP 95 acrylic glass was used for dispersion of an SiO₂-containing mixture of inorganic and organic fillers in the form of quartz sand (Dorfner GmbH), ground quartz (Quarzwerke GmbH) and white pigment particles (Crystal International). Also added were biobased dispersing additives (0.1%) (BYK-Chemie) and thixotropic additives (0.1%) (BYK-Chemie) and internal separating agent (Münzing). After production of the stable dispersion of the filler particles, the peroxide (Pergan GmbH) was added to the casting compound.

In a separate vessel, the ethoxylated p-toluidine (Pergan GmbH) is dissolved in the respective terpene and derivative thereof according to Table 3.

Immediately prior to casting, the ethoxylated p-toluidine solution in the corresponding terpenes and derivatives thereof is added to the casting compound, and the compound is stirred for 2 minutes and injected into the mold at room temperature for 30 minutes.

The quantitative composition of the casting compounds is summarized in Table 3.

TABLE 3
Formulations of the casting compound for redox-induced
polymerization of shaped articles (figures in % by weight)

| Constituents | Speci- | Speci- | Speci- | Speci- | Speci- |
|---|---|---|---|---|---|
| (with specification of | men | men | men | men | men |
| manufacturer) | 3 | 4 | 5 | 6 | 7 |
| Methyl methacrylate, | 19.4 | 19.4 | 19.4 | 19.4 | 19.4 |
| Monómeros del Vallés | | | | | |
| Polymethyl- | 5.7 | 5.7 | 5.7 | 5.7 | 5.7 |
| methacrylate, Kunstoff- | | | | | |
| und Farben GmbH | | | | | |
| Terpineol, International | 8.0 | 0 | 0 | 0 | 0 |
| Flavors & Fragrances | | | | | |
| β-Myrcene, Thermo | 0 | 8.0 | 0 | 0 | 0 |
| Fisher Scientific | | | | | |
| Nerol 900, International | 0 | 0 | 8.0 | 0 | 0 |
| Flavors & Fragrances | | | | | |
| Terpinolene, ARAE | 0 | 0 | 0 | 8.0 | 0 |
| Geraniol, International | 0 | 0 | 0 | 0 | 8.0 |
| Flavors & Fragrances | | | | | |
| PEG(200)DMA, Arkema | 4.0 | 4.0 | 4.0 | 4.0 | 4.0 |
| Peroxide, Pergan GmbH | 0.6 | 0.6 | 0.6 | 0.6 | 0.6 |
| Redox accelerator, | 0.06 | 0.06 | 0.06 | 0.06 | 0.06 |
| Pergan GmbH | | | | | |
| Dispersing additive, | 0.2 | 0.2 | 0.2 | 0.2 | 0.2 |
| BYK-Chemie | | | | | |
| Thixotropic additive, | 0.1 | 0.1 | 0.1 | 0.01 | 0.1 |
| BYK-Chemie | | | | | |
| Quartz filler, Quarzwerke | 53.0 | 53.0 | 53.0 | 53.0 | 53.0 |
| Organic filler, Bio Powder | 6.0 | 6.0 | 6.0 | 6.0 | 6.0 |
| Pigment, Crystal | 3.1 | 3.1 | 3.1 | 3.1 | 3.1 |
| International | | | | | |
| Internal separating | 0.1 | 0.1 | 0.1 | 0.1 | 0.1 |
| agent, Münzing | | | | | |

The casting compound thus produced was stirred for 20 minutes (Dispermat AE-3M, VMA-Getzmann GmbH). Immediately prior to casting, the ethoxylated p-toluidine solution in the respective terpenes and derivatives thereof is added to the casting compound, and the compound is stirred for 2 minutes and poured into a mold at room temperature. The composition was polymerized without external heating for 35 minutes.

TABLE 4
Properties of the specimens from table 3

| | Specimen | Specimen | Specimen | Specimen | Specimen | Comparative |
|---|---|---|---|---|---|---|
| Properties | 3 | 4 | 5 | 6 | 7 | specimen 1 |
| Impact resistance, | 5.4 | 6.1 | 5.0 | 6.0 | 6.3 | 3.0 |
| mJ/mm² | | | | | | |
| Taber abrasion, μg | 20.6 | 19.9 | 27.9 | 20.5 | 19.6 | 21.2 |
| Steam test | 1.05 | 1.27 | 0.42 | 0.88 | 1.61 | 1.03 |
| DE: color change | | | | | | |
| Cleanability, DE: | 1.12 | 1.52 | 0.90 | 0.91 | 1.16 | 3.39 |
| color change | | | | | | |

All specimens 3-7 especially show a great improvement, sometimes by more than a factor of two, in impact resistance compared to the comparative specimen (corresponding to the formulation from Example 1). Cleanability is also noticeably improved.

### Example 3

The use of two or more polymerizable terpenes and derivatives thereof in the casting compound for the production of shaped articles is effected under the same conditions as described in Example 2. The compounds for production of polymer matrices were by dissolving finely ground XP 95 acrylic glass (recycled PMMA, Kunststoff-und Farben-GmbH) in the mixture of methyl methacrylate (Monómeros del Vallés) and polyethylene glycol (PEG)200 dimethacrylate (PEG200DMA). The reaction mixture was heated to 40° ° C. in order to accelerate solubility to 100 min, in order to obtain a clear solution.

The clear solution of finely ground XP 95 acrylic glass was used for dispersion of an SiO₂-containing mixture of inorganic and organic fillers in the form of quartz sand (Dorfner GmbH), ground quartz (Quarzwerke GmbH) and white pigment particles (Crystal International). Also added were biobased dispersing additives (0.1%) (BYK-Chemie) and thixotropic additives (0.1%) (BYK-Chemie) and internal separating agent (Münzing). After production of the stable dispersion of the filler particles, the peroxide (Pergan GmbH) was added to the casting compound.

In a separate vessel, the ethoxylated p-toluidine (Pergan GmbH) is dissolved in the respective terpene and derivative thereof according to Table 3.

Immediately prior to casting, the ethoxylated p-toluidine solution in the mixture of terpineol (International Flavors & Fragrances) and ß-myrcene (Thermo Fisher Scientific) is added to the casting compound, and the compound is stirred for 2 minutes and injected into the mold at room temperature for 30 minutes.

The quantitative composition of the casting compound is summarized in Table 5.

TABLE 5
Formulation of the casting compound according to
Specimen 8 (figures in % by weight)

| Constituents (with specification of manufacturer) | Specimen 8 |
|---|---|
| Methyl methacrylate, Monómeros del Vallés | 19.4 |
| Polymethylmethacrylate, Kunststoff-und Farben-GmbH | 5.7 |
| Terpineol, International Flavors & Fragrances | 8.0 |
| β-Myrcene, Thermo Fisher Scientific | 5.0 |
| PEG(200)DMA, Arkema | 4.0 |
| Peroxide, Pergan GmbH | 0.6 |
| Redox accelerator, Pergan GmbH | 0.06 |
| Dispersing additive, BYK-Chemie | 0.2 |
| Thixotropic additive, BYK-Chemie | 0.1 |
| Quartz filler, Quarzwerke | 53.0 |
| Organic filler, Bio-Powder | 6.0 |
| Pigment, Crystal International | 3.5 |
| Internal separating agent, Münzing | 0.1 |

The casting compound thus produced was stirred for 20 minutes (Dispermat AE-3M, VMA-Getzmann GmbH). Immediately prior to casting, the ethoxylated p-toluidine solution in the respective terpenes and derivatives thereof is added to the casting compound, and the compound is stirred for 2 minutes and poured into a mold at room temperature. The composition was polymerized without external heating for 35 minutes.

TABLE 6
Properties of the specimens from table 5

| Properties | Specimen 8 | Comparative specimen 1 |
|---|---|---|
| Impact resistance, mJ/mm² | 8.1 | 3.0 |
| Taber abrasion, μg | 18.4 | 21.2 |
| Steam test, DE: color change | 1.01 | 1.03 |
| Cleanability, DE: color change | 1.24 | 3.39 |

The use of the mixture of two polymerizable terpenes, terpineol and β-myrcene, leads to the unusual synergy in the mechanical properties of the shaped article of the invention. In particular, an extreme increase in impact resistance and improvement in cleanability have been found.

### Example 4

The use of different concentrations of the terpineol for production of the shaped articles by redox-induced polymerization is examined in this example.

The casting compositions and shaped articles were produced by the technology described in Example 2, using 6.0 and 2.0 parts of the terpineol in samples 9 and 10 respectively. A comparative sample of the casting composition and of the shaped article in which terpineol was replaced by equivalent parts of methyl methacrylate.

The quantitative composition is summarized in Table 7.

TABLE 7
Formulations of the casting compounds with different terpene
concentrations (figures in % by weight)

| Constituents (with specification of | Specimen | Specimen | Comparative |
|---|---|---|---|
| manufacturer) | 9 | 10 | specimen 2 |
| Methyl methacrylate, Monómeros | 19.4 | 19.4 | 19.4 |
| del Vallés | | | |
| Polymethylmethacrylate, | 5.7 | 5.7 | 5.7 |
| Kunststoff-und Farben-GmbH | | | |
| Terpineol, International Flavors & | 6.0 | 2.0 | 0 |
| Fragrances | | | |
| Methyl methacrylate, Monómeros | 0 | 0 | 6.0 |
| del Vallés | | | |
| PEG(200)DMA, Arkema | 4.0 | 4.0 | 4.0 |
| Peroxide, Pergan GmbH | 0.6 | 0.6 | 0.6 |
| Redox accelerator, Pergan GmbH | 0.06 | 0.06 | 0.06 |
| Dispersing additive, BYK-Chemie | 0.2 | 0.2 | 0.2 |
| Thixotropic additive, BYK-Chemie | 0.1 | 0.1 | 0.1 |
| Quartz filler, Quarzwerke | 53.0 | 53.0 | 53.0 |
| Organic filler, Bio-Powder | 6.0 | 6.0 | 6.0 |
| Pigment, Crystal International | 3.5 | 3.5 | 3.5 |
| Internal separating agent, Münzing | 0.1 | 0.1 | 0.1 |

The casting compound thus produced was stirred for 20 minutes (Dispermat AE-3M, VMA-Getzmann GmbH). Immediately prior to casting, the ethoxylated p-toluidine solution in the respective terpenes and derivatives thereof is added to the casting compound, and the compound is stirred for 2 minutes and poured into a mold at room temperature. The composition was polymerized without external heating for 35 minutes.

TABLE 8
Properties of the specimens from table 7

| | Specimen | Specimen | Comparative |
|---|---|---|---|
| Properties | 9 | 10 | specimen 2 |
| Impact resistance, mJ/mm² | 5.7 | 5.6 | 5.6 |
| Taber abrasion, μg | 18.6 | 18.7 | 18.4 |
| Steam test, DE: color change | 1.11 | 1.02 | 0.93 |
| Cleanability, DE: color change | 1.24 | 1.56 | 3.07 |

The specimens produced show the comparable mechanical and surface properties with the comparative sample of the molded article, but there is a distinct increase in cleanability with the addition even of a small amount of the terpineol.

It was also found that the demolding process is simpler when the polymerizable terpenes and derivatives thereof are used. It is common knowledge that, during the polymerization of methacrylate-based monomers, the diffusion limitation of chain termination leads to a significant acceleration of polymerization and an increase in chain length. This leads to an extreme increase in temperature, called the Trommsdorff effect. In the curing of acrylate composites, such high temperature peaks destroy both the separating agent and the gelcoat at the mold surfaces, which damages the mold and the molded article.

The various features of novelty which characterize the invention are pointed out with particularity in the claims annexed to and forming a part of the disclosure. For a better understanding of the invention, its operating advantages, specific objects attained by its use, reference should be had to the drawings and descriptive matter in which there are illustrated and described preferred embodiments of the invention.

FIG. 1 shows the temperature profile during the polymerization of comparative sample 1 that has been produced solely from the acrylic resin. Plotted along the abscissa is the time, and along the ordinate the temperature in the polymerizing casting compound. The temperature maximum is given as about 120° C., which is much higher than the boiling point of methyl methacrylate (MMA). MMA vapors penetrate into the micropores of the gelcoat and delaminate the coating.

FIG. 2 shows the temperature profile of the curing of sample 3 containing 8.0% by weight of terpineol. Plotted along the abscissa is the time, and along the ordinate the temperature in the polymerizing casting compound. As the diagram shows, the temperature does not rise higher than 80° C., which distinctly reduces the aggressive effect of the MMA vapors.

FIG. 3 shows the molded article of the comparative sample, which was subjected to the temperature profile according to FIG. 1 in the course of production. The white color of the surface of the molded article is partly covered by the black spots of the adhering gelcoat. The gelcoat was destroyed by the MMA vapors, resulting in sticking or caking of the gelcoat and possibly mold material on the shaped body, which is manifested in the form of the black spots.

By contrast, the reduced polymerization temperature according to FIG. 2 prevents damage to the molds, and the molded article is demolded without adhering material, as shown in FIG. 4. FIG. 4 shows the molded article that has been subjected to the temperature profile according to FIG. 2 in the course of its production. The molded article was demoldable without any residue, meaning that the separation from the mold existed even during the polymerization and the gelcoat layer remained intact.

Additional features in the case of use of the polymerizable terpenes and derivatives thereof are their ability to be used in combination with recycled materials, for example ground kitchen sinks, sanitary ware or industrial wastes of the ground molds, and recycled inorganic fillers.

### Example 5

The use of the formulation containing the recycled material from a kitchen sink that had been produced and then ground according to DE 38 32 351 A1 was examined.

TABLE 9
Formulations of the casting compound containing recycled
filler material (figures in % by weight)

| Constituents (with specification of manufacturer) | Specimen 11 |
|---|---|
| Methyl methacrylate, Monómeros del Vallés | 21.2 |
| Polymethylmethacrylate, Kunststoff-und Farben-GmbH | 4.1 |
| Terpineol, International Flavors & Fragrances | 4.2 |
| PEG(200)DMA, Arkema | 2.9 |
| Peroxide, Pergan GmbH | 0.6 |
| Redox accelerator, Pergan GmbH | 0.06 |
| Recycled calcium carbonate, Omya GmbH | 7.2 |
| Dolomite, JKSM Lipiński Sp. j. | 21.6 |
| Recyclate from ground sink waste, Schock | 38.2 |

The casting compound produced (specimen 11) was stirred for 20 minutes (Dispermat AE-3M, VMA-Getzmann GmbH). Immediately prior to casting, the ethoxylated p-toluidine solution in the respective terpenes and derivatives thereof is added to the casting compound, and the compound is stirred for 2 minutes and poured into a mold at room temperature. The composition was polymerized without external heating for 35 minutes.

TABLE 10
Properties of specimen 11 from table 9

| Properties | Specimen 11 |
|---|---|
| Impact resistance, mJ/mm² | 2.6 |
| Taber abrasion, μg | 13.1 |
| Steam test, DE: color change | 0.35 |
| Cleanability, DE: color change | 1.43 |

The sample produced using the recycled material from a used kitchen sink and recycled calcium carbonate showed the properties that are comparable with the molded article made from conventional materials.

While specific embodiments of the invention have been shown and described in detail to illustrate the inventive principles, it will be understood that the invention may be embodied otherwise without departing from such principles.

### BRIEF DESCRIPTION OF THE DRAWING

FIG. 1 shows the temperature profile during the polymerization of comparative sample 1.

FIG. 2 shows the temperature profile of the curing of sample 3.

FIG. 3 shows the molded article of the comparative sample, which was subjected to the temperature profile according to FIG. 1.

FIG. 4 shows the molded article that has been subjected to the temperature profile according to FIG. 2.

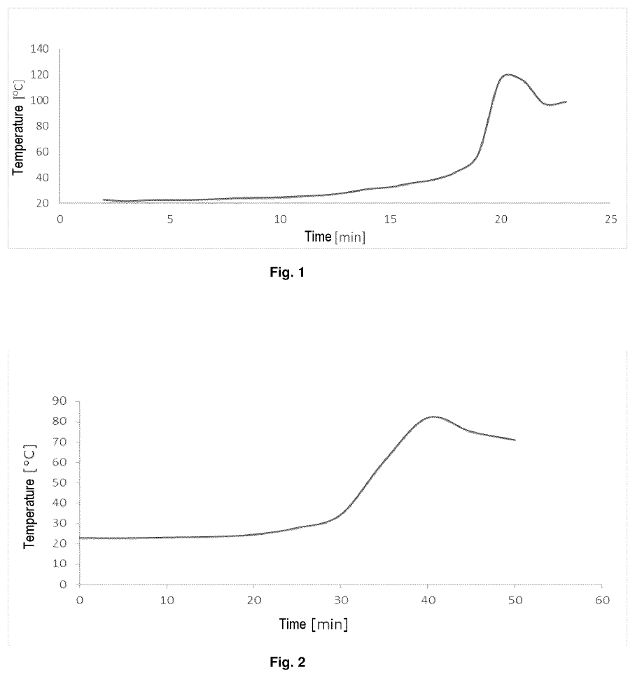

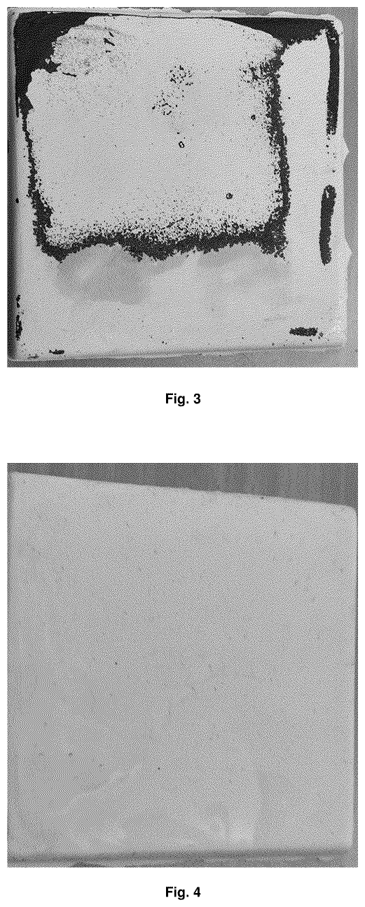

We claim:

1. A thermoset polymerizable casting compound, formulated for production of kitchen sinks and sanitary ware, comprising:
(a) one or more monofunctional acrylic and/or methacrylic monomers, where one or more monomers come from recycled material and/or one or more monomers are of plant or animal origin,
(b) one or more polyfunctional acrylic and/or methacrylic biomonomers of plant or animal origin,
(c) one or more polymers or copolymers selected from (co)polyacrylates, (co)polymethacrylates, polyols, polyesters, rosins, polyterpene resins, each from recycled material or of plant or animal origin,
where the substances according to (a)-(c) form a polymer binder,
(d) inorganic and/or organic filler particles of natural origin or from recycled material, wherein the proportion of the monofunctional acrylic and/or methacrylic monomer(s) and of the polyfunctional acrylic and methacrylic biomonomer(s) is 10-40% by weight, the proportion of the polymer(s) or copolymer(s) is 1-16% by weight, the proportion of the inorganic and/or organic filler particles is 44-89% by weight, and the polymer binder further comprises at least one polymerizable terpene or derivatives thereof.

2. The thermoset casting compound according to claim 1, wherein the casting compound comprises a mixture of two or more polymerizable terpenes and derivatives thereof.

3. The thermoset casting compound according to claim 1, wherein the polymerizable terpene(s) and derivatives thereof or two or more terpenes and derivatives thereof that form the mixture are selected from α-terpineol, β-terpineol, γ-terpineol, terpinen-4-ol terpinolene, (Z)-2,6-dimethyl-2,6-octadien-8-ol and myrcene.

4. The thermoset casting compound according to claim 1, wherein the proportion of terpene and derivatives thereof or mixtures of terpenes and derivatives thereof is in the range of 0.1-20% by weight, preferably 0.8-15% by weight, more preferably 1-10% by weight.

5. The thermoset casting compound according to claim 1, wherein the proportion of the polyfunctional (meth)acrylic monomers is of petrochemical origin and recycled, or of biobased origin and non-recycled, and is in the range of 0.5-20% by weight, preferably 0.8-15% by weight, more preferably 1-10% by weight.

6. The thermoset casting compound according to claim 1, wherein the filler particles comprise inorganic filler particles, organic filler particles, recyclate or a combination thereof.

7. The thermoset casting compound according to claim 6, wherein the inorganic filler particles are selected from SiO₂, Al₂O₃, TiO₂, ZrO₂, Fe₂O₃, ZnO, Cr₂O₅, SiC, CaCO₃, BaSO₄, carbon, metals or metal alloys or mixtures thereof.

8. The thermoset casting compound according to claim 6, wherein the organic filler particles are selected from ground olive kernels, almond kernels, peach kernels, cherry kernels, apricot kernels, avocado peel, argan shells.

9. The thermoset casting compound according to claim 6, wherein the recyclate is produced from ground shaped articles made from a thermoset casting compound.

10. The thermoset casting compound according to claim 6, wherein the inorganic and organic filler particles and the recyclate preferably have a particle size of 1 to 1200 μm, more preferably 25 to 1000 μm and especially 50 to 800 μm.

11. The shaped body produced using a thermoset casting compound according to claim 1.

12. The shaped body according to claim 11, wherein the shaped article is a kitchen sink, a shower tray, a wash basin, a bathtub.

13. The method of producing a shaped body, in which a casting compound according to claim 1 is used and is introduced into a mold in which the casting compound is polymerized under cold-curing conditions using a redox-induced curing system.

14. The method of producing a shaped body according to claim 13, wherein the casting compound is polymerized in the mold at a temperature of 10 to 70° C., preferably 12 to 50° C., more preferably 15 to 30° C.

15. The method of producing a shaped body, in which a casting compound according to claim 1 is used and is introduced into a mold in which the casting compound is polymerized by a heat-induced curing system.

16. The method of producing a shaped body according to claim 15, wherein the casting compound is polymerized in the mold at a temperature of 70 to 120° C., preferably 80 to 110° C., more preferably 90 to 100° C.
